(19) United States
(12) Patent Application Publication
(10) Pub. No.: US 2025/0251586 A1
(43) Pub. Date: Aug. 7, 2025

(54) HOLOGRAM DATASET GENERATION USING RECONFIGURABLE INTELLIGENT SURFACES

(71) Applicant: HUAWEI TECHNOLOGIES CO., LTD., Shenzhen (CN)

(72) Inventors: Sami Mekki, Boulogne Billancourt (FR); Mustapha Amara, Boulogne Billancourt (FR); Mohamed Kamoun, Boulogne Billancourt (FR); Melissa Duarte Gelvez, Boulogne Billancourt (FR)

(73) Assignee: HUAWEI TECHNOLOGIES CO., LTD., Shenzhen (CN)

(21) Appl. No.: 19/188,959

(22) Filed: Apr. 24, 2025

Related U.S. Application Data
(63) Continuation of application No. PCT/EP2022/079561, filed on Oct. 24, 2022.

(51) Int. Cl. G02B 26/08; G02F 1/29

(52) U.S. Cl. CPC G02B 26/085; G02F 1/292; G02F 2202/30

(57) ABSTRACT

The disclosure provides an apparatus for generating a hologram dataset of a target object. The apparatus comprises a DCS with scattering elements having a controllable phase shift, and a controller configured to control the DCS, using a set of control codewords, to scatter an electromagnetic signal of a transmitter onto the target object and to focus the electromagnetic signal reflected from the target object onto a receiver. Each control codeword defines a respective phase shift configuration for at least a subset of the scattering elements, and the target object is illuminated with the electromagnetic signal scattered by the DCS under a different angle than for the other control codewords and/or the electromagnetic signal reflected from the target object is focused onto the receiver under a different angle than for the other control codewords. The controller generates the hologram dataset based on the focused electromagnetic signal received by the receiver.

### CROSS-REFERENCE TO RELATED APPLICATIONS

This application is a continuation of International Application No. PCT/EP2022/079561, filed on Oct. 24, 2022, the disclosure of which is hereby incorporated by reference in its entirety.

### TECHNICAL FIELD

The present disclosure relates to holograms and to the generation of hologram datasets. The disclosure provides an apparatus and a method for generating the hologram dataset of a target object. The apparatus and method thereby use reconfigurable intelligent surfaces, provided by a digitally controllable scatterer (DCS), for illuminating the target object and obtaining the hologram dataset based on the electromagnetic signal reflected from the target object.

### BACKGROUND

Electromagnetic radio wave imaging technology, such as Terahertz and mm-Wave imaging, has gained a lot of interest with a large range of applications in the biomedical domain, non-invasive evaluation, quality control, and security domain. These techniques rely on the measurement of the electric field that is scattered by an irradiated or illuminated target object of interest.

For example, FIG. 1 shows a monostatic scanning setup for obtaining a hologram dataset of a target object 101, wherein a transmitter (Tx) and a receiver (Rx) are collocated and placed on a moving scanning arm 102. The scanner is moved on the scanning plane, and for each position on the scanning plane the Rx measures the scattered signal by the target object 101. The total acquired measurements of the electric field constitute the hologram dataset of the target object 101, which is necessary for image recovery.

Unfortunately, the scanning process, as depicted in FIG. 1, suffers from slow data acquisition, because of the raster scanning process that generates undesired delays, which pose an issue on the speed of the hologram generation. During the hologram generation, the scanning process time relies essentially on the speed of the equipment for scanning, and on the number of considered scanning positions on the scanning plane. Indeed, the speed of the measurement depends on the speed of the scanning process, which is mainly delayed due to the moving arm 102. Thus, as the number of scanning positions increases, in order to get accurate high image resolution during the recovery process, the required scanning time proportionally increases. As the number of the sample points gets high, the acquisition time may take several hours.

In addition, the scanning process itself is not error-free. In fact, a positioning error may occur and accumulate throughout the scanning process of the target object 101, due to successive displacements of the scanning arm 102, each time the moving arm changes its position to scan the next target point.

Additional costs for the system setup arise in case the aperture of the Tx antenna is enhanced with a dedicated lens. Indeed, in order to illuminate the whole target object 101 at once from any position, an adapted lens is typically used. However, this is not without consequence, since the lens performance is highly tied to the construction quality, i.e., the material used for the construction to deviate the signal with minimum signal distortion.

### SUMMARY

In view of the above, this disclosure aims to improve the conventional way and setup for hologram dataset generation. An objective is to enable a faster generation of the hologram dataset of a target object. Another objective is to minimize errors when generating the hologram dataset, for instance, by providing a more reliable and accurate scanning method. Another objective is to provide an apparatus for generating the hologram dataset, which is compact and of low cost, or provides flexible deployment of the Tx and Rx.

These and other objectives are achieved by this disclosure according to the solutions described in the independent claims. Advantageous implementations are further described in the dependent claims.

A first aspect of this disclosure provides an apparatus for generating a hologram dataset of a target object, the apparatus comprising: a DCS comprising one or more scattering surfaces that comprise a set of scattering elements, each scattering element having a controllable phase shift; a transmitter configured to transmit an electromagnetic signal onto the DCS during a scanning period; a controller configured to control the DCS, using a set of control codewords during the scanning period, to scatter the electromagnetic signal onto the target object and to focus the electromagnetic signal reflected from the target object onto a receiver; and the receiver arranged to receive the electromagnetic signal focused by the DCS; wherein each control codeword defines a respective phase shift configuration for at least a subset of the scattering elements of the DCS, wherein, for each control codeword, the target object is illuminated with the electromagnetic signal scattered by the DCS under a different angle than for the other control codewords and/or the electromagnetic signal reflected from the target object is focused onto the receiver under a different angle than for the other control codewords, and wherein the controller is further configured to generate the hologram dataset of the target object based on the focused electromagnetic signal received by the receiver during the scanning period.

The positions of the involved entities, e.g., transmitter, receiver, and the one or more DCS surfaces may be static and fixed during the scanning period, in which the scanning process is performed. The conventionally required position change of any of these entities can be emulated by applying the set of control codewords defining the specific phase shift configurations at the one or more DCS surfaces. For example, each codeword may mimic a different transmitter and/or receiver position in the sense that, although the transmitter and the receiver are not moving, the controlled scattering generated by the one or more DCS surfaces is such that the electric field at the receiver is the same, as if the receiver and/or the transmitter were moving and scanning from different positions. Applying the entire set of control codewords may provide a set of received measurements, which corresponds to the desired hologram dataset of the target object.

Since moving entities, or entities with multiple antennas, are not required, the costs of the apparatus are low. In addition, a faster generation of the hologram dataset of a target object is possible than if the involved entities had to be moved. Also errors when generating the hologram dataset can be minimized, due to the fact that positioning errors are avoided.

In an implementation form of the first aspect, the position of the transmitter, the position of the receiver, and the positions and orientations of the one or more scattering surfaces of the DCS, are fixed relative to each other and relative to the target object during the scanning period.

In an implementation form of the first aspect, the transmitter and the receiver are collocated; the DCS comprises a scattering surface that comprises the set of scattering elements; and the controller is configured to control the set of scattering elements of the scattering surface, using the set of control codewords during the scanning period, to scatter the electromagnetic signal onto the target object and to focus the electromagnetic signal reflected from the target object onto the receiver.

This implementation provides a solution for collocated transmitter and receiver, e.g., transceiver, wherein a single DCS surface can be used. This provides a compact and cheap setup.

In an implementation form of the first aspect, the transmitter and the receiver are non-collocated; the DCS comprises a scattering surface that comprises the set of scattering elements; the controller is configured to control a first subset of the scattering elements of the scattering surface, using a first subset of the control codewords during the scanning period, to scatter the electromagnetic signal onto the target object; and the controller is configured to control a second subset of the scattering elements of the scattering surface, using a second subset of the control codewords during the scanning period, to focus the electromagnetic signal reflected from the target object onto the receiver.

The first subset of the scattering elements and the second subset of the scattering elements may be non-overlapping subsets, that is, no scattering element of the first subset is in the second subset and vice versa. However, it is also possible that the first subset of the scattering elements and the second subset of the scattering elements may be overlapping subsets, that is, one or more scattering elements of the first subset may be included in the second subset and vice versa.

This implementation provides a solution for a non-collocated transmitter and receiver, wherein a single DCS surface can be used. This provides a compact but flexible solution

In an implementation form of the first aspect, the DCS comprises no other scattering surface than the scattering surface that comprises the set of scattering elements.

In an implementation form of the first aspect, the transmitter and the receiver are non-collocated; the DCS comprises a first scattering surface that comprises a first subset of the scattering elements and a second scattering surface that comprises a second subset of the scattering elements; the controller is configured to control the first subset of the scattering elements of the first scattering surface, using a first subset of the control codewords during the scanning period, to scatter the electromagnetic signal onto the target object; and the controller is configured to control the second subset of the scattering elements of the second scattering surface, using a second subset of the control codewords during the scanning period, to focus the electromagnetic signal reflected from the target object onto the receiver.

This implementation provides a solution for non-collocated transmitter and receiver, wherein two or more DCS surfaces can be used. This enables a very precise hologram dataset generation.

In an implementation form of the first aspect, the first scattering surface and the second scattering surface are separate parts of the DCS and are independently controllable by the controller.

In an implementation form of the first aspect, the controller is configured to control the DCS to scatter the electromagnetic signal as a plane electromagnetic wave, for each control codeword, onto the target object.

This allows illuminating the whole target object and improves the generation of the hologram dataset.

In an implementation form of the first aspect, the set of control codewords forms a codebook, wherein the codebook is adapted to the transmitter, to the receiver, and to characteristics of the one or more scattering surfaces of the DCS.

The characteristics may be related to the position and orientation of each of the one or more DCS surfaces and/or to each of the DCS scattering elements. In particular, the characteristics may include the position and orientation of the one or more DCS surfaces and the DCS scattering elements of these DCS surfaces.

In an implementation form of the first aspect, the controller is configured to generate the codebook based on at least the relative positions of the transmitter, the receiver, the one or more scattering surfaces of the DCS, and the target object.

In an implementation form of the first aspect, the controller is configured to generate the codebook with the set of control codewords being selected such, that the scattering of the electromagnetic signal by the DCS onto the target object, when using the set of control codewords during the scanning period, emulates a reflection of a perfect electric conductor (PEC) with the shape of a paraboloid of revolution.

This leads to a very accurate hologram dataset of the target object.

In an implementation form of the first aspect, the controller is configured to obtain the respective relative positions of the transmitter, the receiver, the target object, and the one or more scattering surfaces of the DCS, and respective characteristics of the one or more scattering surfaces of the DCS, by signaling from at least one of the transmitter and the receiver.

In an implementation form of the first aspect, at least one of the transmitter and the receiver is configured to perform a measurement of the relative position of the target object relative to the transmitter and the receiver.

A second aspect of this disclosure provides a method for controlling an apparatus for generating a hologram dataset of a target object, the apparatus comprising: a DCS comprising one or more scattering surfaces that comprise a set of scattering elements, each scattering element having a controllable phase shift; a transmitter configured to transmit an electromagnetic signal onto the DCS during a scanning period; and a receiver arranged to receive an electromagnetic signal reflected from the target object onto the DCS and focused by the DCS onto the receiver during the scanning period; and the method comprising: controlling the DCS, using a set of control codewords during the scanning period, to scatter the electromagnetic signal onto the target object and to focus the electromagnetic signal reflected from the target object onto the receiver; wherein each control codeword defines a respective phase shift configuration for at least a subset of the scattering elements of the DCS, wherein, for each control codeword, the target object is illuminated with the electromagnetic signal scattered by the DCS under a different angle than for the other control codewords and/or the electromagnetic signal reflected from the target object is focused onto the receiver under a different angle than for the other control codewords; and generating the hologram dataset of the target object based on the focused electromagnetic signal received by the receiver during the scanning period.

In an implementation form of the second aspect, the position of the transmitter, the position of the receiver, and the positions and orientations of the one or more scattering surfaces of the DCS, are fixed relative to each other and relative to the target object during the scanning period.

In an implementation form of the second aspect, the transmitter and the receiver are collocated; the DCS comprises a scattering surface that comprises the set of scattering elements; and the method comprises controlling the set of scattering elements of the scattering surface, using the set of control codewords during the scanning period, to scatter the electromagnetic signal onto the target object and to focus the electromagnetic signal reflected from the target object onto the receiver.

In an implementation form of the second aspect, the transmitter and the receiver are non-collocated; the DCS comprises a scattering surface that comprises the set of scattering elements; the method comprises controlling a first subset of the scattering elements of the scattering surface, using a first subset of the control codewords during the scanning period, to scatter the electromagnetic signal onto the target object; and the method comprises controlling a second subset of the scattering elements of the scattering surface, using a second subset of the control codewords during the scanning period, to focus the electromagnetic signal reflected from the target object onto the receiver.

In an implementation form of the second aspect, the DCS comprises no other scattering surface than the scattering surface that comprises the set of scattering elements.

In an implementation form of the second aspect, the transmitter and the receiver are non-collocated; the DCS comprises a first scattering surface that comprises a first subset of the scattering elements and a second scattering surface that comprises a second subset of the scattering elements; the method comprises controlling the first subset of the scattering elements of the first scattering surface, using a first subset of the control codewords during the scanning period, to scatter the electromagnetic signal onto the target object; and the method comprises controlling the second subset of the scattering elements of the second scattering surface, using a second subset of the control codewords during the scanning period, to focus the electromagnetic signal reflected from the target object onto the receiver.

In an implementation form of the second aspect, the first scattering surface and the second scattering surface are separate parts of the DCS and are independently controllable.

In an implementation form of the second aspect, the method comprises controlling the DCS to scatter the electromagnetic signal as a plane electromagnetic wave, for each control codeword, onto the target object.

In an implementation form of the second aspect, the set of control codewords forms a codebook, wherein the codebook is adapted to the transmitter, to the receiver, and to characteristics of the one or more scattering surfaces of the DCS.

In an implementation form of the second aspect, the method comprises generating the codebook based on at least the relative positions of the transmitter, the receiver, the one or more scattering surfaces of the DCS, and the target object.

In an implementation form of the second aspect, the method comprises generating the codebook with the set of control codewords being selected such, that the scattering of the electromagnetic signal by the DCS onto the target object, when using the set of control codewords during the scanning period, emulates a reflection of a perfect electric conductor with the shape of a paraboloid of revolution.

In an implementation form of the second aspect, the method comprises obtaining the respective relative positions of the transmitter, the receiver, the target object, and the one or more scattering surfaces of the DCS, and respective characteristics of the one or more scattering surfaces of the DCS, by signaling from at least one of the transmitter and the receiver.

In an implementation form of the second aspect, at least one of the transmitter and the receiver performs a measurement of the relative position of the target object relative to the transmitter and the receiver.

The method of the second aspect and its implementation forms achieve the same advantages as described above for the apparatus of the first aspect and its respective implementation forms.

A third aspect of this disclosure provides a computer program comprising instructions which, when the program is executed by a processor, cause the processor to perform the method according to the second aspect or its implementation forms, in particular, for controlling the DCS and for generating the hologram dataset.

A fourth aspect of this disclosure provides a non-transitory storage medium storing executable program code which, when executed by a processor, causes the method according to the second aspect or its implementation forms to be performed.

According to the above, in this disclosure, an apparatus for hologram dataset generation is proposed, wherein the apparatus is designed to use surfaces or meta-surfaces of a DCS that are configured to manipulate propagating electromagnetic waves emitted by a transmitter and scattered by a target object in ways such that a set of signals observed at a receiver correspond to a hologram dataset measurement.

A surface or meta-surface of any DCS may be composed of a large number (e.g., hundreds or thousands) of unit cells each being a scattering element with a controllable phase shift. Thus, the phase of the electromagnetic wave scattered by a unit element of a DCS surface can be controlled. The proposed apparatus is capable of scanning the target object by using the one or more DCS surfaces with a specific set of configurations defined by control codewords, which are specifically designed for the scanning process enabling the hologram dataset generation.

Thereby, the position of the involved entities, e.g., the transmitter antenna(s), the receiver antenna(s) and the one or more DCS surfaces may be static and fixed during the scanning period. Any needed position change of any of these entities can be emulated by applying the control codewords at the one or more DCS surfaces. A codeword may thereby be defined for a DCS as a respective phase shift value for each scattering element, and the set of different codewords may define a codebook for the DCS.

In this disclosure, moving or multiple antenna elements are not required. Instead, the described DCS programming may be used to manipulate the propagating electromagnetic waves, such that at the receiver the electric field measurements required for the hologram dataset generation can be acquired. A codebook can be used for configuring the DCS, the codebook including the control codewords and being adapted to the transmitter, the receiver, the DCS, and the target object for scanning. Each control codeword in the codebook may mimic a different transmitter and/or receiver position in the sense that, although the transmitter and the receiver are not moving, the controlled scattering generated by the DCS is such that the electric field at the receiver is the same as if the receiver and/or the transmitter were moving and scanning from different positions. Applying the entire codebook may provide a set of received measurements, which corresponds to the desired hologram dataset of the target object.

The solutions of this disclosure could be integrated into a stand-alone device, or could be implemented as a network assisted solution for environment or object scanning. For instance, the proposed apparatus could be embedded into a stand-alone device like a smartphone, wherein the transmitter, the receiver, and the DCS are fixed and their positions are known. The position of the scanned target object may also be known prior to the scanning process. This can be achieved by placing the target object or scanner in a specific area, or it could be estimated using available sensors on the device (such as proximity sensor). With such devices, position changes do not have to be applied to scan the target object and to generate the hologram. All that may be required is to position the device at a fixed position from the target object.

Alternatively, for instance, it is also possible to take advantage of the known positions of one or more base stations (BSs) and of various deployed DCS surfaces in a propagation environment for performing the scanning. Indeed, the BSs (Tx/Rx) position and deployed DCS surfaces are known, and thus the solutions of this disclosure can be used to scan a fixed target object without moving either the BSs (i.e., Tx/Rx) nor the DCS. Of course, signaling and synchronization may be required between the BSs and the DCS, in order to update the phase shifts of the DCS scattering elements of the one or more DCS surfaces of the DCS. This may emulate the effect of illuminating the target object and focusing the reflected signal towards the desired Rx antenna, and also to control the transmit/receive processes every time a new codeword in the codebook is selected.

The advantages of this disclosure include that it allows alleviating the issues mentioned above, such as the conventionally long acquisition time for hologram dataset generation, the positioning error that may accumulate during a raster scanning process, and the usage of high quality lenses necessary to illuminate the whole target object with parallel rays and refocus the reflected rays back towards the receiver. Since the solutions of this disclosure do not require a scanning arm, the delays due to the scanning arm placement are eliminated, and the errors usually accumulated by the mechanical arm during the scanning process are removed. In fact, in this disclosure, the positioning error disappears naturally, once the positions of transmitter, receiver, DCS, and the target object are fixed and well identified.

Therefore, the approach of this disclosure may comprise fixing the positions of the transmitter, the receiver, and the target object once and for all during the scanning/acquisition process during the scanning period, in order to not suffer from the accumulated error caused by the moving arm of the scanner. With the help of static one or more DCS surfaces, configured with a well-designed codeword, it is possible at the same time to illuminate a whole target object and focus the reflected electromagnetic waves by the target object onto the receiver. Moreover, following this disclosure, it is possible to mimic position changes of any of the transmitter or the receiver or the target object, just by updating the codeword that configures the phase shift of the DCS scattering elements. The choice of the codewords in the codebook may also determine the quality of the resulting hologram dataset.

In this disclosure, also a method for DCS codebook generation is proposed, wherein the method is tailored to the hologram dataset acquisition described above. The proposed codebook generation method may be based on the reflection properties of paraboloids, which meet the requirements of illuminating the whole target object (by generating plane waves, e.g., parallel rays) and focusing reflected waves on the receiver (e.g., paraboloid focusing). The DCS phase shifts of a codeword may be chosen such that the wave scattered by the DCS is the same as if it had been reflected by a paraboloid shaped mirror.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an example of a conventional monostatic scanning setup for generating a hologram dataset.

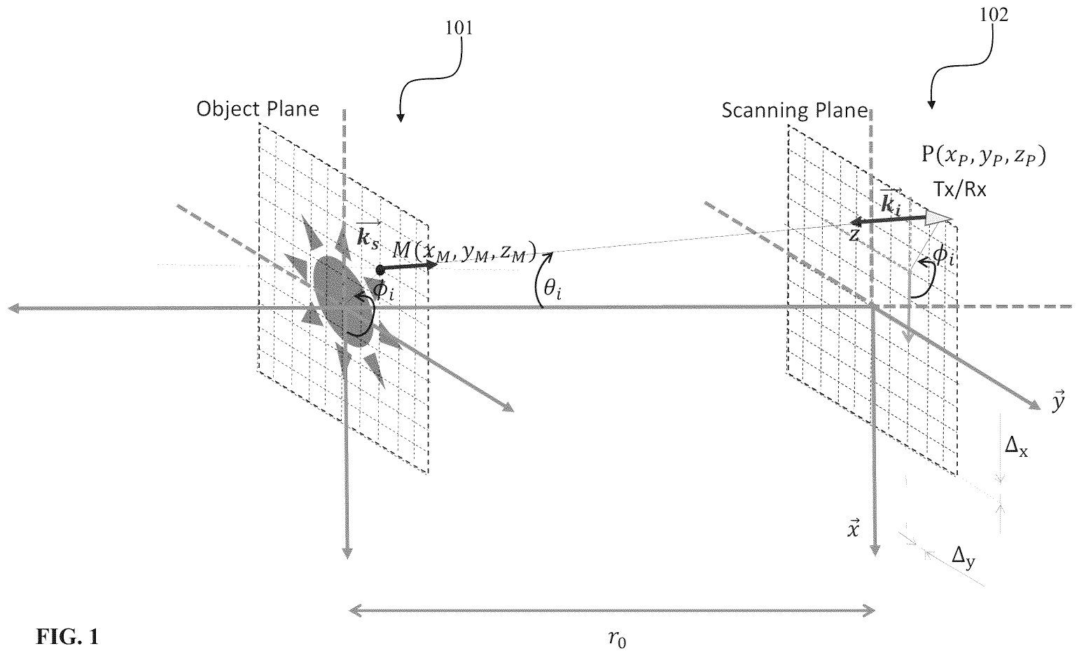

FIG. 2 shows an apparatus for generating a hologram dataset according to this disclosure with an exemplary two DCS surfaces.

FIG. 3 shows a flowchart of an exemplary hologram dataset generation method using a codebook.

FIG. 4 shows an example of two scattered waves generated by applying two different codewords to a DCS having as example one DCS surface.

FIG. 5 shows a scattered wave with an optimized DCS having as example one DCS surface.

FIG. 6 illustrates the construction of a tangent point P.

FIG. 7 illustrates the construction of a directrix D.

FIG. 8 illustrates the construction of a paraboloid.

FIG. 9 shows a target object illumination with a plane electromagnetic wave scattered from a DCS surface.

FIG. 10 illustrates the computing of a phase shift compensation, as example, a codeword computation based on a paraboloid geometrical approach.

FIG. 11 shows an example of an apparatus for hologram dataset generation with two exemplary DCS surfaces in a bi-static configuration.

FIG. 12 shows exchanged messages for a hologram dataset generation with a transmitter and receiver in the same stand-alone device.

FIG. 13 shows exchanged messages for a network assisted hologram dataset generation.

FIG. 14 shows a method for generating a hologram dataset according to this disclosure.

FIG. 15 shows exemplary configurations of scattering surfaces of a DCS.

### DETAILED DESCRIPTION OF EMBODIMENTS

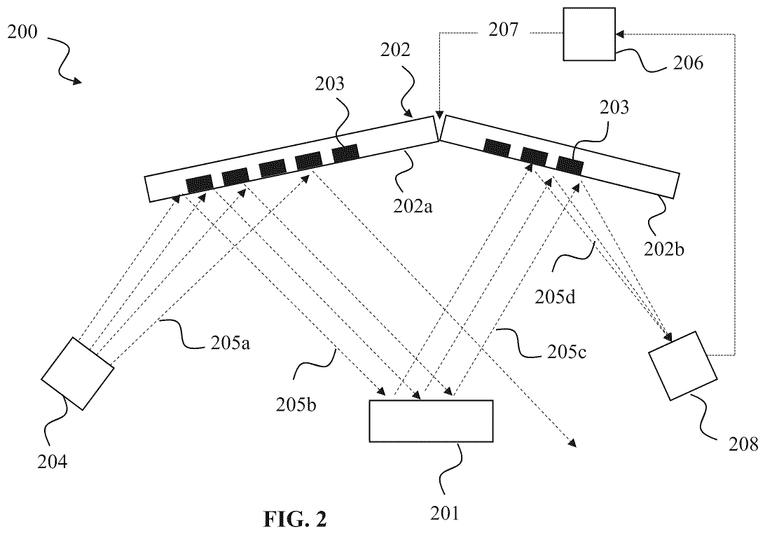

FIG. 2 shows an apparatus 200 according to this disclosure. The apparatus 200 is configured to generate a hologram dataset of a target object 201. The apparatus 200 comprises a DCS 202 with one or more scattering surfaces 202a, 202b. In FIG. 2, just as an example, the DCS 202 comprises two scattering surfaces 202a and 202b. As shown later, the DCS 202 can also include only one scattering surface, or can also include more than two scattering surfaces. The apparatus 200 further comprises a transmitter 204, a receiver 208, and a controller 206. The positions of the receiver 208, and the positions and orientations of the one or more scattering surfaces 202a, 202b of the DCS 202, may be fixed relative to each other and relative to the target object 201 during a scanning period, in which the apparatus 200 acquires the hologram dataset, i.e., performs the scanning process. The relative positions of the transmitter 204, the receiver 208, the DCS 202, and the target object 201 may be fixed and known, at least during the scanning period.

The one or more scattering surfaces 202a, 202b of the DCS 202 comprise a set of scattering elements 203. In FIG. 2, as example, the DCS 202 has a first scattering surface 202a and a second scattering surface 202b. Each scattering element 203 of each scattering surface, 202a, 202b has a controllable phase shift, which may be controlled by the controller 206. In particular, the controller 206 is configured to control the DCS 202 by using a set of control codewords 207 during the scanning period. The transmitter 204 is configured to transmit an electromagnetic signal 205a onto the DCS 202 during the scanning period. The control codewords 207 are selected and designed such that the electromagnetic signal 205a is scattered by the DCS 202 as scattered electromagnetic signal 205b onto the target object 201. Moreover, the controller 206 may also control the DCS 202 to focus the reflected electromagnetic signal 205c reflected from the target object 201 as focused electromagnetic signal 205d onto the receiver 208. The receiver 208 is arranged to receive the electromagnetic signal 205d focused by the DCS 202.

Each control codeword 207 notably defines a respective phase shift configuration for at least a subset of the scattering elements 203 of the DCS 202. For each control codeword 207, the target object 201 is illuminated with the electromagnetic signal 205b scattered by the DCS 202 under a different angle than for the other control codewords 207. Additionally or alternatively, the electromagnetic signal 205c reflected from the target object 201 is focused onto the receiver 208 under a different angle for each control codeword 207 than for the other control codewords 207.

The controller 206 is then further configured to generate the hologram dataset of the target object 201 based on the focused electromagnetic signal 205d received by the receiver 208 during the scanning period. The arrow from the receiver 208 to the controller 206 represents exchanges that provide the controller 206 with the collected measurement at the receiver 208 for hologram generation.

The controller 206 may comprise a processor or processing circuitry (not shown) configured to perform, conduct or initiate the various operations of controller 206 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The controller 206 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of controller 206 to be performed. In one embodiment, the processing circuitry comprises one or more processors and a non-transitory memory connected to the one or more processors. The non-transitory memory may carry executable program code which, when executed by the one or more processors, causes the controller 206 to perform, conduct or initiate the operations or methods described herein.

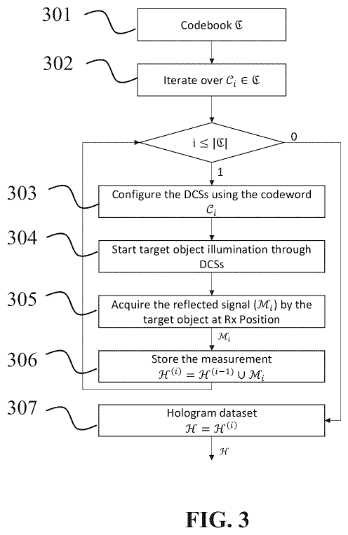

FIG. 3 shows a flowchart of an exemplary hologram dataset generation method, which may be performed by the apparatus 200, using a given codebook 301 (codebook [symbol] ). Each codeword 207 (codeword [symbol] ) from the codebook 301 may fulfill a set of requirements as described in the following:
Each codeword 207 in the codebook 301 mimics a different position of the transmitter 204 and/or the receiver 208.
The signal 205b scattered by the DCS 202 towards the target object 201 comprises plane waves, i.e., parallel rays to illuminate the target object 201.
As the target object 201 is illuminated, the reflected signal 205c by the target object 201 is focused on the receiver 208 through a pre-configured DCS surface or DCS surface group of the DCS 202.

The above characteristics allow selecting a set of codewords 207 or phase shift configuration of the scattering elements 203 of the DCS 202 among infinite configuration of phase shifts. Once a phase profile configuration meets these characteristics, it forms a codeword 207 and the set of these codewords 207 form the codebook 301.

Hence, the target object may be irradiated or illuminated under a different angle for each codeword 207 than for the other codewords 207, thanks to the phase profile configuration of the scattering surfaces of the DCS 202 that is achieved based on the codeword 207 from the codebook 301. For this, the apparatus 200 may iterate 302 over all codewords 207 of the codebook 301. For each iteration, the apparatus 200 may configure 303 the DCS 202 according to the codeword 207, start 304 illuminating the target object 201 via the DCS 202, acquire 305 the signal 205c reflected from the target object 201, and store 306 the measurement. Applying, the entire codebook 301 provides a set of acquisition measurements, which corresponds to and obtains 307 the desired hologram dataset of the target scanned object 201. The hologram dataset may be obtained by collecting all the measurement { [symbol] } for the given codebook [symbol] .

Next will be described how a codebook 301 can be constructed. Any codeword 207 from the desired codebook 301 may be required to meet the following conditions:
Each codeword 207 in the codebook 301 mimics a different position of the transmitter 204 and/or the receiver 208.
The signal 205b scattered by the DCS 202 towards the target object 201 comprises plane waves, i.e. parallel rays to illuminate the target object 201.
As the target object 201 is illuminated, the reflected signal 205c by the target object 201 is focused on the receiver 208 through a pre-configured DCS surface or DCS surface group of the DCS 202

Several tools and approaches can be considered in the construction of such codewords 207, among them, for instance, geometrical based approaches, selection from larger random codebooks, machine learning based construction with online and/or offline learning approaches, raytracing based approximation and simulations, and/or EM field simulations with optimization processes.

In the following, the disclosure describes in detail the construction process based on a geometrical approach, as an example of codeword construction. In fact, based on the conditions defined above, the codewords 207 can be designed to emulate the behavior of reflection from a mirror or PEC that has the shape of a paraboloid of revolution, wherein the transmitter 204 is the focal point of the said paraboloid and the DCS 202 is scattering the transmitted signal 205a towards the target object 201 with a plane wave. At the same time, the reflected signal 205c by the target object 201 are focused in the receiver 208 position with the same DCS configuration for a monostatic setup. In order to facilitate the construction of codewords 207 that fulfill the above requirements, the codeword design may consider only paraboloids of revolution that are tangent to a DCS surface.

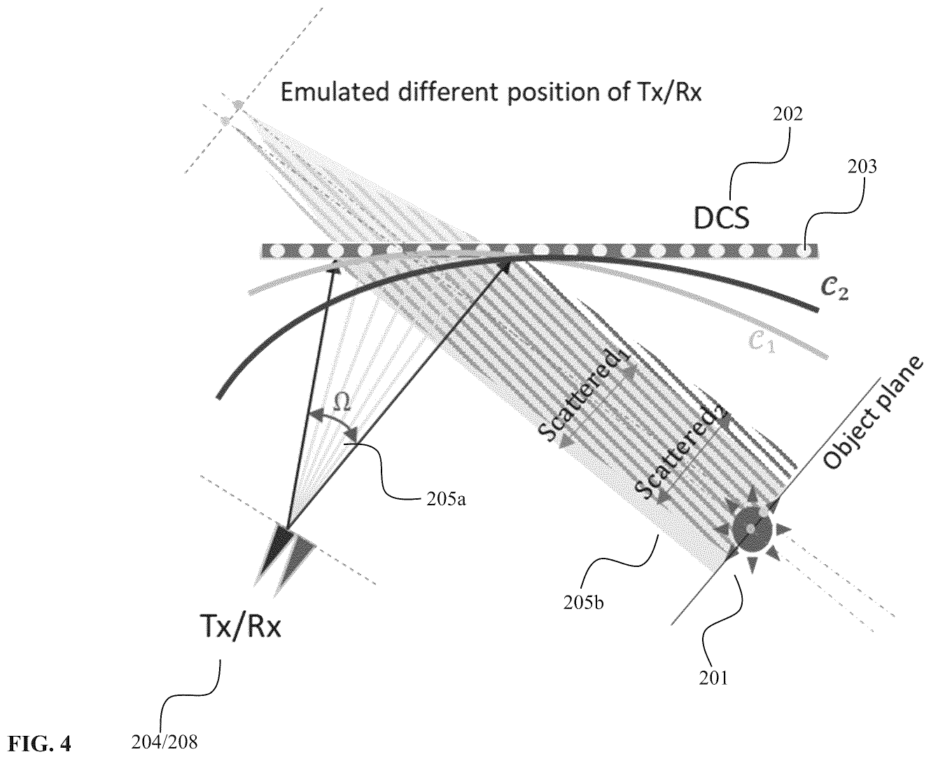

FIG. 4 displays an example of transmitter 204 and receiver 208 position emulation. Each applied codeword 207 is configured to illuminate, or irradiate, the target object 201 with plane waves at different angle of view. Thus, the acquired data measures the reflected signal 205c by the target object 201 at different angle of view for each respective codeword 207. Accordingly, the total number of codewords 207 that form the codebook 301 is proportional to the number of angles of view that has been considered to illuminate the target object 201.

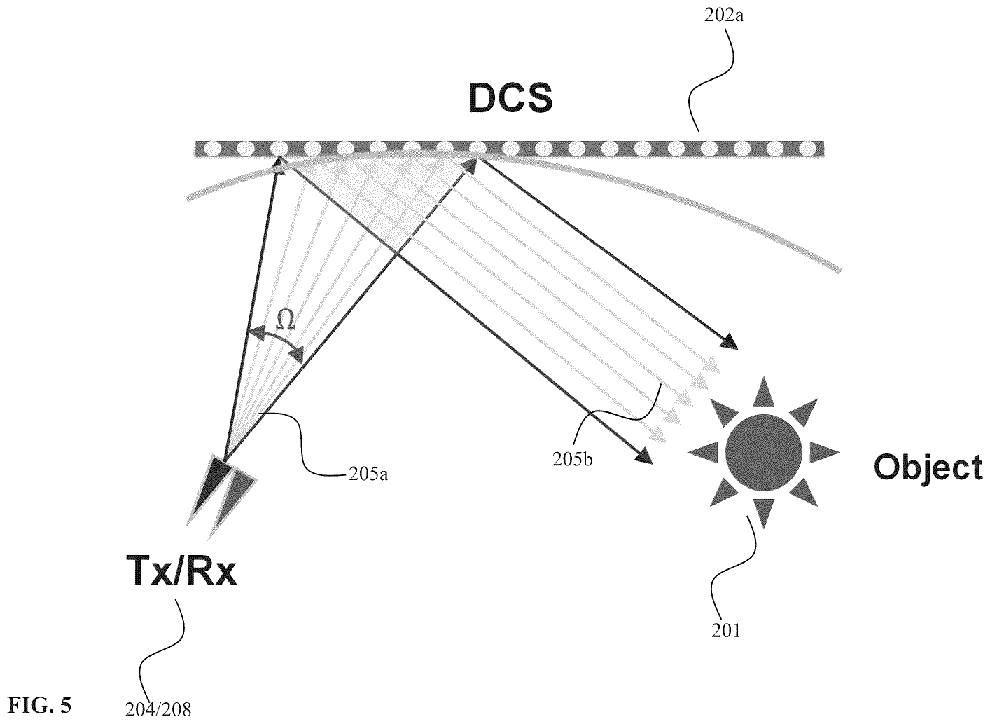

The construction of a codeword 207 for a given angle of view position and given focal point is now described. In particular, a method is presented for a codeword construction for one measurement acquisition. The codeword 207, i.e., the desired phase shift configuration that will be applied to the DCS elements 203 of the DCS 202, aims to transform the impinging signal 205a at the one or more DCS surfaces into a plane wave signal 205b as shown in FIG. 5 for the example of one scattering surface 202a of the DCS 202. Then, the reflected signal 205c by the target object 201 are collected and focused on the receiver 208 position with the same setup configuration without any change in the monostatic measurement.

As the paraboloid shape meets the properties for DCS phase shift configurations mentioned above, the disclosure describes now how to emulate a paraboloid of revolution that is tangent to the DCS surface 202a and has as a focal point the transmitter 204 and receiver 208a position in a monostatic configuration, i.e., the transmitter 204 and the receiver 208 are collocated. The bi-static configuration is described later. The method presented here is a geometrical method based on simple geometric operation.

To be able to illuminate the whole target object 201 at once, the DCS 202 is configured such that the scattered wave 205b by the DCS 202 is the same as if it had been reflected by a paraboloid shaped mirror. In other words, the DCS 202 mimics the reflection behavior of a paraboloid of revolution with the following features:
Transmitter 204 and receiver 208 position is the focal of the paraboloid of revolution.
The directrix plane [symbol] of the paraboloid is perpendicular to the parallel rays that illuminate the target object 201.
A paraboloid is chosen that is tangent to the DCS surface 202a, in order to guarantee the unicity of such paraboloid. This provides a simple computable solution while relaxing the latest constraint would provide solutions with an equally shifted phase pattern and thus would not change the outcome of the phase profile structure of the codewords 207.
The reflected signal 205c by the target object 201 illuminated with the plane wave, i.e. parallel rays, is focused into one point that corresponds to the focal of the paraboloid, i.e., the receiver 208 position.

In what follows, the necessary steps for the paraboloid-based codebook construction are described.

Based on the position of the transmitting and receiving antennas of the transmitter 204 and the receiver 208, respectively, the target object 201 coordinates and the DCS position, the identification process of the optimal paraboloid for codeword construction may go as follows:
STEP 1. Construct a first point P of the paraboloid that would be tangent to the DCS 202. The construction procedure is described later.
STEP 2. Get the directrix-plane of the paraboloid.
STEP 3. Compute the equation of the paraboloid of revolution
STEP 4. Compute the phases to be applied on the DCS elements 203, i.e., the codeword 207.
STEP 5. Apply the obtained codeword 207 on DCS scattering elements 203.

More details on the paraboloid construction are provided below.

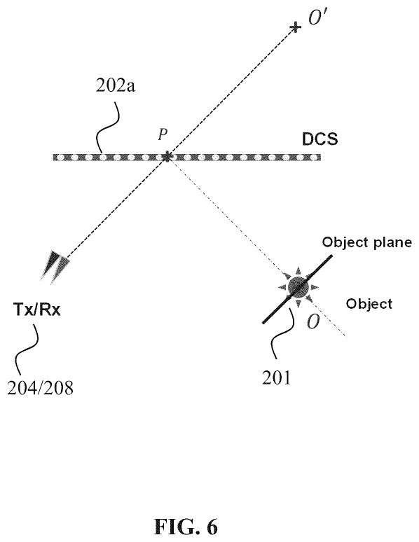

In a first step, a first point P of the desired paraboloid, a paraboloid of revolution may be constructed, that is the tangent to the DCS surface 202a on P. This step, though not necessary, can guarantee the unicity of the proposed paraboloid and may provide a practical and simple solution for computing the paraboloid. Relaxing this condition would provide solutions with similar phase patterns up to a modulo factor. FIG. 6 depicts the construction process of the tangent point.

The tangent point P may be obtained by applying the following steps:
a. Fix the center of the main object O.
b. Construct O′, the image of O, through an orthogonal symmetry with respect to the plane of the DCS surface 202a.
C. Point P is then the intersection between the line (RxO′) and the plane of the DCS surface 202a. This point is the tangent point between the desired paraboloid and the DCS surface plane.
d. Chose the object plane as the perpendicular plane to the line (PO) in O.

The directrix axis of a parabola is the line perpendicular to the axis of symmetry of the parabola and any point of the parabola is at equal distance between the focal of the parabola and the line known as directrix axis. Since the paraboloid of revolution is obtained by rotating a parabola over its symmetry axis, the directrix plane of a paraboloid is the plane [symbol] that is perpendicular to the symmetry axis of the paraboloid and any point of the paraboloid is at equal distance between the focal point of the paraboloid and the directrix plane of the paraboloid of revolution. Thus, to construct the directrix plane of the paraboloid that is tangent to the DCS surface 202a at point P and having Tx/Rx (transmitter 204/receiver 208) as its focal, one may proceed as follows:
a. The axis perpendicular to line (PRx) at Rx position within the plane defined by the points (O, P, Rx) intersects the DCS plane in point Q which belongs to the directrix plane [symbol]
b. The directrix plane [symbol] could be obtained through two methods:
   i. Method 1: the directrix is the second tangent to the circle of center P with radius RxP and passing through Q
   ii. Method 2: the directrix plane [symbol] is the perpendicular to RxQ passing through Q

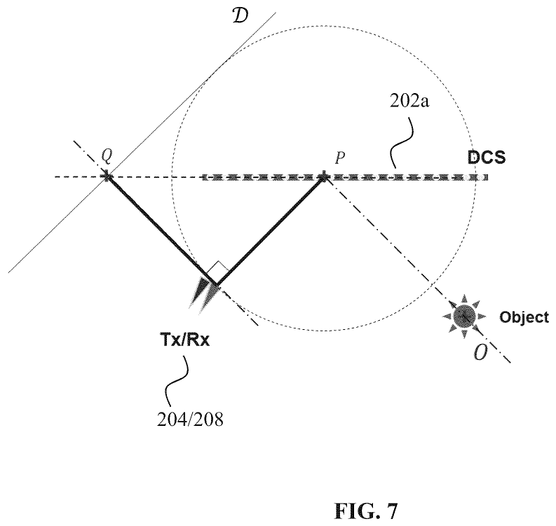

FIG. 7 shows the construction procedure of the directrix plane [symbol] of the praboloid of revolution with focal Tx/Rx and tangent to the DCS surface 202a at point P.

In the next step, the paraboloid of revolution equation may be defined that has Tx/Rx as focal and tangent to the DCS surface 202a at point P with directrix plane [symbol] as defined in step 2.
a. The orthogonal projection of the focal point Tx/Rx on the directrix allows to get the parameter p (the semi-latus rectum) which is the minimum distance between Tx/Rx and the directrix plane [symbol] .
b. Once the parameter p is defined we are now capable to get the paraboloid of revolution equation using as

$${x}^{2} + {y}^{2} = 2 p z \qquad ( 1 )$$

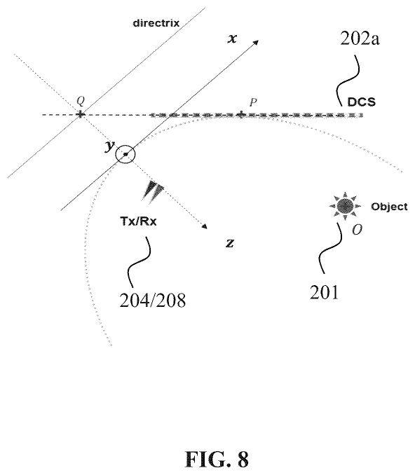

FIG. 8 shows the result of paraboloid construction based on the steps described previously.

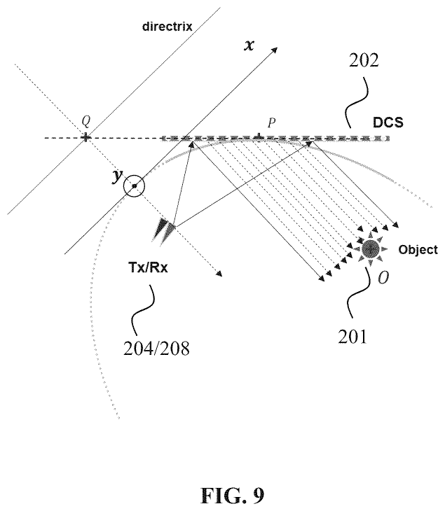

After computing the paraboloid parameters defined by equation (1), the phase shifts may be computed that need to be applied to the DCS scattering elements 203, in order to scatter with the same characteristics as a reflection of the constructed paraboloid. This ensures that the target object 201 is illuminated with parallel rays as depicted in FIG. 9.

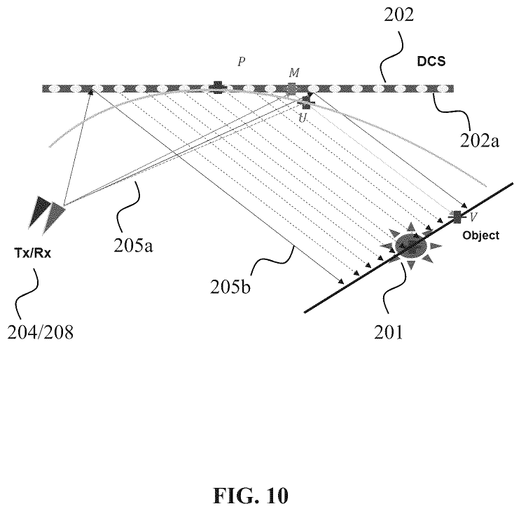

For this, one may assume if a signal 205a ray from Tx hits the DCS 202 at point M as shown in FIG. 10, the scattered signal 205b by the DCS surface should be parallel to the paraboloid axis and hits the object plane at V, the scattered signal at M intersects the paraboloid surface in point U. The path difference between the first path defined by Tx, M and V and the second path defined by Tx, U and V, as shown in FIG. 10, provides the extra phase that needs to be compensated at the DCS 202 to match the reflection from the paraboloid. Mathematically stated, the phase shift that has to be applied for each DCS scattering element 203 is computed as

$${ϕ}_{c} = \frac{2 π}{λ} ( ‖ \vec{TxM} ‖ + ‖ \vec{MV} ‖ - ‖ \vec{TxU} ‖ - ‖ \vec{UV} ‖ ) \qquad ( 2 )$$

where λ is the wave length and ∥·∥ is the Euclidian norm operator.

For each desired scanning point V from the object plane, STEP 1 to STEP 5 may be applied, in order to get the desired phase shift or the codeword 207 as

$${ϕ}_{c} ( V ) = \frac{2 π}{λ} ( ‖ \vec{TxM} ‖ + ‖ \vec{MV} ‖ - ‖ \vec{TxU} ‖ - ‖ \vec{UV} ‖ ) \qquad ( 3 )$$

A codebook 301 is obtained by constructing a codeword for each scanning point in a set of scanning points from the target object plane.

It is worth mentioning at this point that as the construction is geometrical based, the codeword 207 can be obtained as an analytical solution in function to the relative position of: the transmitter 204, the receiver 208 and the DCS 202. And as such, only one expression may need to be stored in the apparatus 200.

Further, this disclosure now describes how a hologram dataset could be acquired or generated in a bi-static configuration, i.e., the transmitter 204 and the receiver 208 are not collocated. In this configuration, two (or more) DCS surfaces 202a, 202b are to be used, one surface 202a for target object illumination and the second surface 202b for reflected rays focusing on the receiver 208 position. It is also possible to use one DCS surface 202a where the surface is split into two categories, each of which is dedicated either to the illumination of the target object 201 or the focusing of the reflected rays by the target object on the receiver 201. Each of the two categories may comprise a subset of scattering elements 203 of the DC surface 202a, wherein the two subsets of scattering elements 203 may overlap or may be non-overlapping. It is also possible to use one DCS surface 202a, wherein the scattering elements 203 are used during a first time period for target object illumination and in a second time period for reflected ray focusing on the receiver 208.

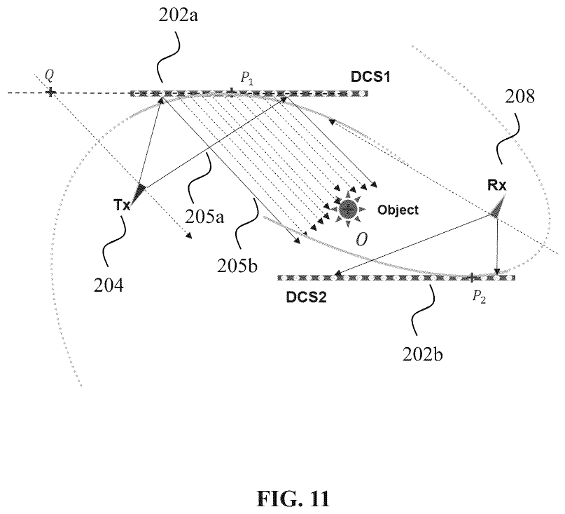

In FIG. 11, an example of such a setup is shown where two DCS surfaces 202a, 202b are used for dataset acquisition in a bi-static configuration.

The first DCS surface 202a, i.e. DCS1, is in charge of illuminating the target object 201 and the second DCS surface 202b, i.e. DCS2, is in charge of focusing the reflected rays 205c by the target object 201 on Rx (receiver 208) antenna.

The DCS1 is configured in order to illuminate the target object 201 with parallel rays. The DCS2 focuses the signal 205d on the receiver 208 as the DCS2 is configured with a codeword 207 that mimics reflection from a PEC with the shape of a paraboloid of revolution with focal receiver 208 position. The codeword update procedure is performed according to the steps described previously (step 1 to 5). To obtain the codeword for DCS1 the transmitter 204 is the focal of the desired paraboloid of revolution. To obtain the codeword for DCS2 the receiver 208 is the focal of the desired paraboloid of revolution.

The bi-static setup allows to minimize the self-interference between the antennas of the transmitter 204 and the receiver 208.

The transmitter 204 and the receiver 208 for implementation of the proposed solution could be embedded into a stand-alone device, e.g., a smartphone or any device that embeds fixed transmitter 204 and fixed receiver 208, collocated or not. The DCS surfaces could be in the same stand-alone device or placed at fixed distance from the transmitter 204 and receiver 208, and the object plane. The position of the scanned object 201 could be estimated using available sensors on the device, e.g., using proximity sensor, or Lidar, or any other sensor that provides the range according to each entity. With the idea of this disclosure, there is no need for a scanning movement to get the hologram of the object 201, the device may just be positioned at a fixed location from the target object to be scanned. The DCS phase shift configuration can be managed by the controller 206, which may assign the appropriate codeword(s) 207 to the DCS surfaces.

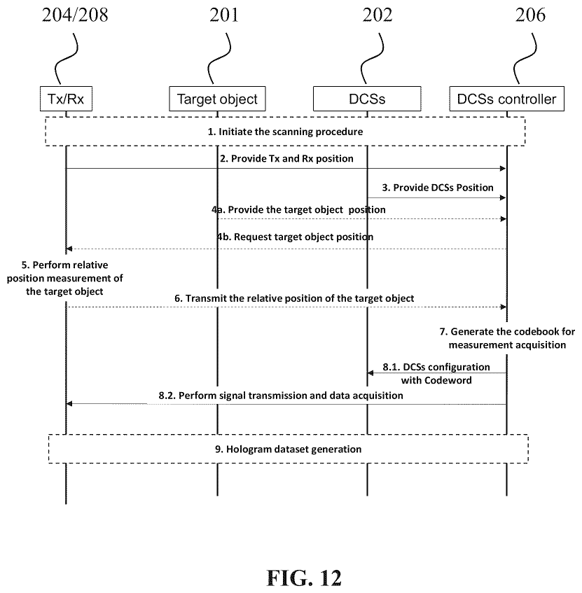

FIG. 12 shows different possible exchanged messages between the DCS controller 206 and the involved entities, in order to perform hologram measurement. FIG. 12 particularly shows an example of exchanged signaling that enables to use the proposed idea when the transmitter 204 and receiver 208 are part of a stand-alone device and the DCS 202 is not part of such device.

In step 1, any of the involved entities could initiate the scanning procedure.

In steps 2 and 3, the DCS controller 206 may try to get the position of the involved devices for target object scanning. The Tx/Rx are the transmitter 204 and receiver 208 that could be collocated or not.

The target object 201 could be any object that is capable to communicate with the scanner or a simple random object. If the target object 201 is active and is aware about its position, the DCS controller 206 may ask directly the target object 201 to transmit its position in step 4a. However, if the target object 201 is passive, the DCS controller 206 may ask the transmitter 204 and/or receiver 208 to perform the measurement of the relative position of the target object 201 in step 4b.

Then in step 5, the transmitter 204 and/or receiver 208 may perform all the necessary measurements to estimate the relative position of the target object 201. Afterwards, the transmitter 204 and/or receiver 208 may provide the estimated position of the target object 201 to the DCS controller 206 in step 6.

Once all the required information are available at the DCS controller 206, the DCSs controller 206 may generate the codebook 301 for configuring the DCS scattering surfaces in step 7.

In step 8.1, the DCS controller 206 may transmit the codeword to the one or more DCS surfaces for scattering elements 203 configuration. Besides in step 8.2, the DCS controller 206 may inform the transmitter 204 and/or receiver 208 to perform signal transmission and data acquisition. Each codeword 207 from the codebook 301 allows to configure the DCS surface(s) 202a, 202b such that the transmitted signal 205a is scattered toward the target object 201. The reflected signals 205c by the target object 201 are then focused, through the same DCS surface(s) or different one(s), at the receiver 208 position.

The acquired measurement may constitute one measurement from the whole hologram dataset. Step 8.1 and 8.2 may be iterated over all the codewords 207 from the codebook 301, which may generate the desired hologram in step 9.

It is worth noticing that when the DCS 202 is part of the stand-alone device as well as the transmitter 204, receiver 208, and the DCS controller 206, then the signaling presented in FIG. 12 disappears as it is part of the device itself. The only required external information is the detection/acquisition/request of the position of the target object 201 to be scanned.

The hologram dataset generation could also be performed in a network configuration application where the network entities such as users equipments (UEs) or BSs are part of the scanning system. Of course, in such configurations, one may assume that the one or more DCS scattering surfaces 202a, 202b of the DCS 202 have been deployed and their positions are known to the network. One may assume that there is an entity in the network that may be called “location server” that is configured to manage all of the required position information of all entities in the network. This entity can be distributed or not, integrated into any other entity of the network.

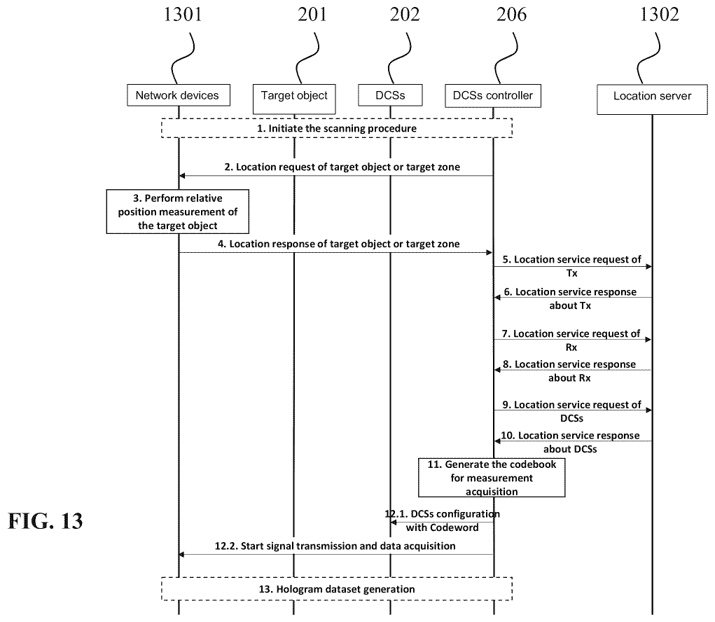

FIG. 13 shows the exchanged signaling between the involved network devices, such as the BSs and UEs, the one or more DCS surfaces of the DCS 202, the target object 201 if it is a part of network element, and the DCS controller 206.

In step 1, any of the involved entities from the network could initiate the scanning procedure.

In step 2, once the DCS controller 206 receives the message of scanning initiation, the DCS controller 206 may ask the network devices in charge of transmission and data acquisition the relative position of the target object 201 or target zone.

In step 3, the network devices 1301 perform all the necessary measurement to estimate the relative position of the target object 201 or the scanning zone.

In step 4, the network devices 1301 transmit the relative position of the target object 201 or zone to the DCS controller 206.

In step 5, the DCS controller 206 requests the position of the transmitter 204, i.e. Tx antenna, to the location server 1302.

In step 6, the location server 1302 sends to the DCS controller 206 the location of the transmitter 204.

In step 7, the DCS controller 206 requests the location of the receiver 208, i.e. Rx antenna to the location server 1302.

In step 8, the location server sends to the DCS controller 206 the location of the receiver 208.

In step 9, the DCS controller 206 requests the location of the involved DCS scattering surfaces(s) in the scanning process.

In step 10, the location server 1302 sends to the DCS controller 206 the location of the one or more scattering surfaces of the DCS 202.

In step 11, the DCS controller 202 generates the codebook necessary to configure the DCS scattering surfaces.

In step 12.1, the DCS controller 206 transmits the codeword 207 to the DCS 202. In step 12.2, the DCS controller 206 triggers the signal transmission and data acquisition.

Step 12.1 and 12.2 are iterated over all the codewords 207 from the codebook 301, in order to generate the desired hologram in step 13.

Optionally, the different functionalities provided by the controller 206 can be distributed in different entities of the network, for example the codeword generation may be performed at the BS and the hologram generation at the UE.

A straightforward generalization of this last implementation can be the consideration of the multiple transmitters 204, receivers 208 and DCS scattering surfaces 202a, 202b that are available in the network, and use them for simultaneous measurements for holograms generation. The advantage of this extension is to provide multiple holograms with different transmitters 204 and/or receivers 208, which may be scanning at once, which provides different holograms of the target object 201.

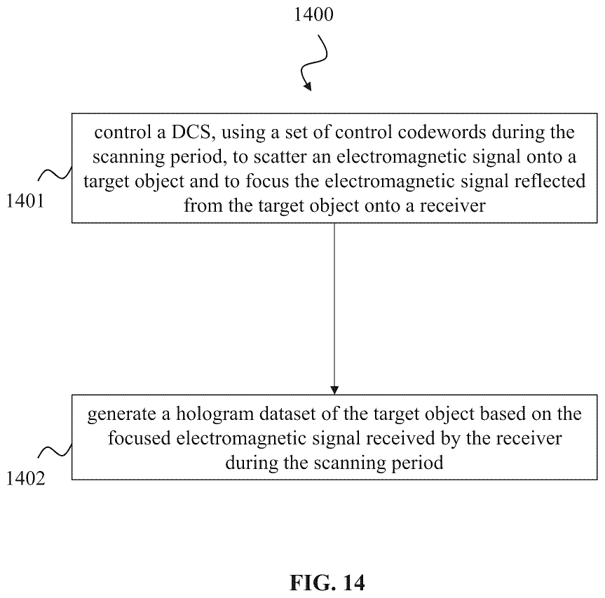

FIG. 14 shows a method 1400 according to this disclosure. The method 1400 is for controlling the apparatus 200 for generating a hologram dataset of a target object 201. Similar to above, the apparatus 200 comprises a DCS 202, a transmitter 204, and a receiver 208.

The method 1400 comprises a step 1401 of controlling the DCS 202, using a set of control codewords 207 during the scanning period, to scatter the electromagnetic signal 205a onto the target object 201 and to focus the electromagnetic signal 205c reflected from the target object 201 onto the receiver 208. For each control codeword 207, the target object 201 is illuminated with the electromagnetic signal 205b scattered by the DCS 202 under a different angle than for the other control codewords 207 and/or the electromagnetic signal 205c reflected from the target object 201 is focused onto the receiver 208 under a different angle than for the other control codewords 207. The method 1400 further comprises a step 1402 of generating the hologram dataset of the target object 201 based on the focused electromagnetic signal 205d received by the receiver 208 during the scanning period.

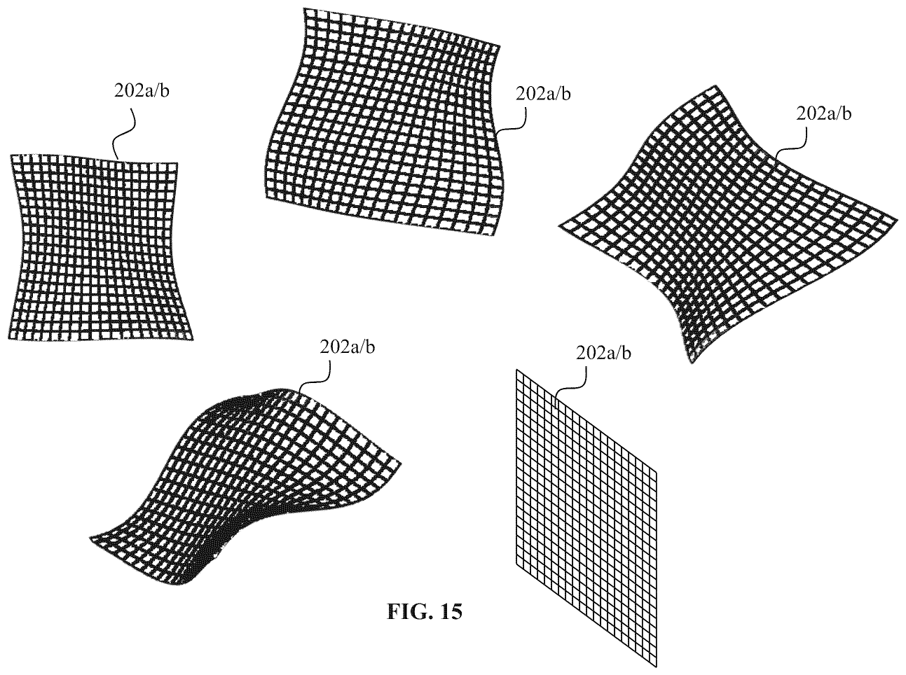

Notably, in this disclosure, a scattering surface 202a, 202b of a DCS 202 may have different configurations. As shown exemplarily in FIG. 15, a scattering surface 202a, 202b of a DCS 202 may have different shapes. For instance, a scattering surface 202a, 202b of a DCS 202 may be planar and non-planar. A DCS 202 may comprise a first scattering surface 202a of a first configuration and a second scattering surface 202b of a second configuration.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An apparatus for generating a hologram dataset of a target object, the apparatus comprising:
a digitally controllable scatterer (DCS) comprising one or more scattering surfaces that comprise a set of scattering elements, wherein each scattering element has a controllable phase shift;
a transmitter configured to transmit an electromagnetic signal onto the DCS during a scanning period;
a controller configured to control the DCS, using a set of control codewords during the scanning period, to scatter the electromagnetic signal onto the target object and to focus the electromagnetic signal reflected from the target object onto a receiver; and
the receiver arranged to receive the electromagnetic signal focused by the DCS,
wherein each control codeword defines a respective phase shift configuration for at least a subset of the scattering elements of the DCS,
wherein, for each control codeword, the target object is illuminated with the electromagnetic signal scattered by the DCS under a different angle than for the other control codewords and/or the electromagnetic signal reflected from the target object is focused onto the receiver under a different angle than for the other control codewords, and
wherein the controller is further configured to generate the hologram dataset of the target object based on the focused electromagnetic signal received by the receiver during the scanning period.

2. The apparatus according to claim 1, wherein a position of the transmitter, a position of the receiver, and positions and orientations of the one or more scattering surfaces of the DCS are fixed relative to each other and relative to the target object during the scanning period.

3. The apparatus according to claim 1, wherein the transmitter and the receiver are collocated and the DCS comprises a scattering surface that comprises the set of scattering elements; and
wherein the controller is configured to control the set of scattering elements of the scattering surface, using the set of control codewords during the scanning period, to scatter the electromagnetic signal onto the target object and to focus the electromagnetic signal reflected from the target object onto the receiver.

4. The apparatus according to claim 1, wherein the transmitter and the receiver are non-collocated and the DCS comprises a scattering surface that comprises the set of scattering elements;
wherein the controller is configured to control a first subset of the scattering elements of the scattering surface, using a first subset of the control codewords during the scanning period, to scatter the electromagnetic signal onto the target object; and
wherein the controller is configured to control a second subset of the scattering elements of the scattering surface, using a second subset of the control codewords during the scanning period, to focus the electromagnetic signal reflected from the target object onto the receiver.

5. The apparatus according to claim 3, wherein the DCS comprises no other scattering surface than the scattering surface that comprises the set of scattering elements.

6. The apparatus according to claim 1, wherein the transmitter and the receiver are non-collocated and the DCS comprises a first scattering surface that comprises a first subset of the scattering elements and a second scattering surface that comprises a second subset of the scattering elements;
wherein the controller is configured to control the first subset of the scattering elements of the first scattering surface, using a first subset of the control codewords during the scanning period, to scatter the electromagnetic signal onto the target object; and
wherein the controller is configured to control the second subset of the scattering elements of the second scattering surface, using a second subset of the control codewords during the scanning period, to focus the electromagnetic signal reflected from the target object onto the receiver.

7. The apparatus according to claim 6, wherein the first scattering surface and the second scattering surface are separate parts of the DCS and are independently controllable by the controller.

8. The apparatus according to claim 1, wherein the controller is configured to control the DCS to scatter the electromagnetic signal as a plane electromagnetic wave, for each control codeword, onto the target object.

9. The apparatus according to claim 1, wherein the set of control codewords forms a codebook adapted to the transmitter, to the receiver, and to characteristics of the one or more scattering surfaces of the DCS.

10. The apparatus according to claim 9, wherein the controller is configured to generate the codebook based on at least the relative positions of the transmitter, the receiver, the one or more scattering surfaces of the DCS, and the target object.

11. The apparatus according to claim 9, wherein the controller is configured to generate the codebook with the set of control codewords being selected such, that the scattering of the electromagnetic signal by the DCS onto the target object, based on using the set of control codewords during the scanning period, emulates a reflection of a perfect electric conductor with the shape of a paraboloid of revolution.

12. The apparatus according to claim 1, wherein the controller is configured to obtain respective relative positions of the transmitter, the receiver, the target object, and the one or more scattering surfaces of the DCS, and respective characteristics of the one or more scattering surfaces of the DCS, by signalling from at least one of the transmitter and the receiver.

13. The apparatus according to claim 11, wherein at least one of the transmitter and the receiver is configured to perform a measurement of the relative position of the target object relative to the transmitter and the receiver.

14. A method for controlling an apparatus for generating a hologram dataset of a target object, wherein the apparatus comprises a digitally controllable scatterer (DCS) comprising one or more scattering surfaces that comprise a set of scattering elements, each scattering element having a controllable phase shift, a transmitter configured to transmit an electromagnetic signal onto the DCS during a scanning period, and a receiver arranged to receive an electromagnetic signal reflected from a target object onto the DCS and focused by the DCS onto the receiver during the scanning period, wherein the method comprises:
controlling the DCS, using a set of control codewords during the scanning period, to scatter the electromagnetic signal onto the target object and to focus the electromagnetic signal reflected from the target object onto the receiver;
wherein each control codeword defines a respective phase shift configuration for at least a subset of the scattering elements of the DCS, and
wherein, for each control codeword, the target object is illuminated with the electromagnetic signal scattered by the DCS under a different angle than for the other control codewords and/or the electromagnetic signal reflected from the target object is focused onto the receiver under a different angle than for the other control codewords; and
generating the hologram dataset of the target object based on the focused electromagnetic signal received by the receiver during the scanning period.
